(19) United States
(12) Patent Application Publication
(10) Pub. No.: US 2026/0250484 A1
(43) Pub. Date: Aug. 27, 2026

(54) CURABLE SILICONE COMPOSITION WITH HIGH HEAT RESISTANCE

(71) Applicant: Momentive Performance Materials Inc., Niskayuna, NY (US)

(72) Inventors: Kaka Dey, Latham, NY (US); David Gascoyne, Schenectady, NY (US); Debanga Bhusan Konwar, Bangalore (IN); Subrata Mandal, Bangalore (IN); Clarissa Miller, Clifton Park, NY (US)

(21) Appl. No.: 19/545,541

(22) Filed: Feb. 20, 2026

(30) Foreign Application Priority Data
Feb. 21, 2025 (IN) 202511015175

(51) Int. Cl. C08K 3/34; C08G 77/26; C08K 3/04; C08K 3/08; C08K 3/38

(52) U.S. Cl. CPC C08K 3/34; C08G 77/26; C08K 3/046; C08K 3/08; C08K 3/38; C08K 2003/0812

(57) ABSTRACT

A silicone composition is shown and described herein. The silicone composition is suitable for use as a coating to provide thermal insulation to an underlying substrate or article. Upon exposure to extremely high temperatures, the silicone composition or a coating formed therefrom forms a ceramic char, which acts as an insulating material to limit the transfer of heat to the underlying surfaces.

### CROSS-REFERENCE TO RELATED APPLICATIONS

This application claims priority to and the benefit of India Provisional Application No. 202511015175 filed on Feb. 21, 2025, titled “CURABLE SILICONE COMPOSITION WITH HIGH HEAT RESISTANCE,” the disclosure of which is incorporated herein by reference in its entirety.

### FIELD OF INVENTION

The present invention relates to a curable silicone composition. In particular, the present invention relates to a silicone composition that exhibits excellent thermal insulation upon exposure to high temperatures, large fluctuations in temperatures, or high heat flux.

### BACKGROUND

Silicone materials find use in a wide range of applications and environments including as coatings, sealants, and the like. These materials may be employed in applications or articles that may be exposed to a wide range of temperatures, extreme temperature fluctuations, and/or extremely high temperatures. As such, it is of interest to provide materials that cannot significantly breakdown or experience significant loss of performance properties upon exposure to extreme temperatures and/or fluctuations in temperature. Additionally, the silicone material may desirably be employed as a layer of protection to the underlying substrate or article from the extreme temperature conditions.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a composition comprising: a base silicone material; from about 5 wt. % to about 50 wt. % of mullite powder based on the total weight of the composition; and from about 1 wt. % to about 35 wt. % of a carbon fiber filler based on the total weight of the composition.

In one embodiment, the composition comprises from about 8 wt. % to about 40 wt. % of mullite powder based on the total weight of the composition.

In one embodiment, the composition comprises from about 2 wt. % to about 10 wt. % of the carbon fiber filler based on the total weight of the composition.

In one embodiment in accordance with any previous embodiment, the composition comprises silicon carbide.

In one embodiment, the silicon carbide is present in an amount of from about 1 wt. % to about 10 wt. % based on the total weight of the composition.

In one embodiment in accordance with any previous embodiment, the composition comprises boric anhydride.

In one embodiment in accordance with any previous embodiment, the boric anhydride is present in an amount of from about 0.5 wt. % to about 5 wt. % based on the total weight of the composition.

In one embodiment in accordance with any previous embodiment, the composition comprises aluminum powder.

In one embodiment in accordance with any previous embodiment, the alumina powder is present in an amount of from about 0 wt. % to about 6 wt. % based on the total weight of the composition.

In one embodiment in accordance with any previous embodiment, the composition comprises an oxide filler selected from alumina, silica, or iron oxide.

In one embodiment in accordance with any previous embodiment, the composition comprises an aryl substituted cyclosiloxane.

In one embodiment in accordance with any previous embodiment, the aryl substituted cyclosiloxane is selected from hexaphenyl cyclotrisiloxane, octaphenyl cyclotetrasiloxane, or a combination thereof.

In one embodiment in accordance with any previous embodiment, the aryl substituted cyclosiloxane is present in an amount of from about 0.5 wt. % to about 3 wt. % based on the total weight of the composition.

In one embodiment in accordance with any previous embodiment, the base silicone material is an addition curable resin comprising an alkenyl-functional polydiorganosiloxane and a hydride-functional polydiorganosiloxane.

In one embodiment in accordance with any previous embodiment, the alkenyl-functional polydiorganosiloxane is selected from a MQ alkenyl-functional resin, and the hydride-functional polydiorganosiloxane is selected from a MQ hydride-functional resin.

In one embodiment in accordance with any previous embodiment, the composition comprises an alkenyl-functional organopolysiloxane.

In one embodiment in accordance with any previous embodiment, the alkenyl-functional organopolysiloxane is selected from an alkenyl-terminated polydimethyldiphenylsiloxane.

In one embodiment in accordance with any previous embodiment, the alkenyl-functional organopolysiloxane is selected from an alkenyl-functional siloxane-imide polymer.

In one embodiment, the alkenyl-functional siloxane-imide polymer is of the formula (i) or (ii):

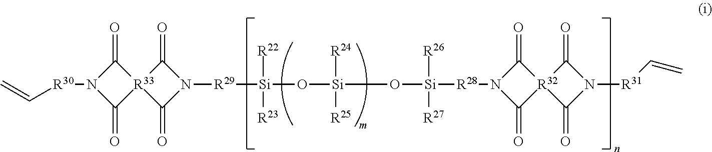

R²², R²³, R²⁴, R²⁵, R²⁶, and R²⁷ are each independently selected from a C1-C10 alkyl and a C6-C20 aryl;
R²⁸ and R²⁹ are independently selected from a divalent C2-C10 alkyl and a divalent C6-C20 aryl-containing groups.
R³⁰ and R³¹ are independently selected from a bond a C1-C20 divalent hydrocarbon, a C4-C20 branched divalent hydrocarbon, or a C4-C30 cyclic containing hydrocarbon group;
R³² and R³³ are independently chosen from a C5-C20 aryl, a polycyclic aryl group comprising two or more C5-C20 aryl groups, where R³² and R³³ can be unsubstituted or substituted with a C1-C6 alkyl, a halogen, a haloalkyl, a hydroxy, and/or a C1-C5 alkoxy groups;
m is an integer from 1 to about 200; and
n is an integer from 1 to about 30;

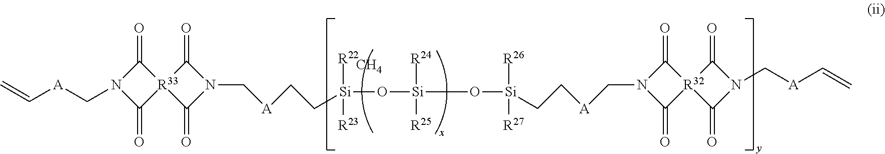

where
R³⁴ and R³⁵ are independently chosen from a C5-C20 aryl, a polycyclic aryl group comprising two or more C5-C20 aryl groups, where R³⁴ and R³⁵ can be unsubstituted or substituted with a C1-C6 alkyl, a halogen, a haloalkyl, a hydroxy, and/or a C1-C5 alkoxy groups; A may be chosen from C5-C20 aryl;
R³⁶, R³⁷, R³⁸, R³⁹, R⁴⁰, and R⁴¹ may be same or different and can be chosen from C1-C10 alkyl and C6-C20 aryl;
x is an integer from 1 to about 200; and
y is an integer from 1 to about 30.

In one embodiment in accordance with any previous embodiment, the composition comprises mullite, silicon carbide, boric anhydride, and an aryl substituted cyclosiloxane.

In one embodiment in accordance with any previous embodiment, the composition comprises from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; and from about 0.5 wt. % to about 10 wt. % of an aryl substituted cyclosiloxane based on the total weight of the composition.

In one embodiment in accordance with any previous embodiment, the composition comprises mullite, silicon carbide, boric anhydride, an aryl substituted cyclosiloxane, and alumina.

In one embodiment in accordance with any previous embodiment, the composition comprises from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; from about 0.5 wt. % to about 10 wt. % of an aryl substituted cyclosiloxane based on the total weight of the composition, and from about 0.1 wt. % to about 5 wt. % of alumina based on the total weight of the composition.

In one embodiment in accordance with any previous embodiment, the composition comprises mullite, silicon carbide, boric anhydride, and carbon fiber.

In one embodiment in accordance with any previous embodiment, the composition comprises from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; and from about 1 wt. % to about 35 wt. % of carbon fiber based on the total weight of the composition.

In one embodiment in accordance with any previous embodiment, the composition is free of an adhesion promoter.

In another aspect, provided is a cured material formed from the composition of any of the previous aspects or embodiments.

In still another aspect, provided is an article comprising a substrate and the cured material of the previous aspect and embodiments disposed on a surface of the substrate.

In one embodiment, the cured material adheres to the surface of the substrate in the absence of a primer between the surface and the coating.

In one embodiment in accordance with any previous embodiment, the substrate is selected from a polymeric substrate, a metallic substrate, a fiber substrate, or a combination of two or more thereof.

In one embodiment in accordance with any previous embodiment, the substrate is selected from, aluminum, copper, nickel, iron, brass, niobium, stainless steel, carbon steel, tungsten, rhenium, molybdenum, titanium containing alloy, a niobium containing alloy, a nickel containing alloy, a copper containing alloy, a titanium containing alloy, an epoxy resin, a polyester resin, a polycarbonate resin, an acrylic resin, a polyimide resin, a phenolic resin, a polyamide resin, a polyphenylene sulfide resin, modified polyphenylene ether (PPE) resin, glass, a woven fiber material, a felt material, a carbon metal alloy, or a combination of two or more thereof.

In one embodiment in accordance with any previous embodiment, the cured material is free of a primer and/or an adhesion promoter.

In one embodiment in accordance with any previous embodiment, the cured material forms a ceramic char at a heat flux of about 20 W/cm² or greater.

In one embodiment in accordance with any previous embodiment, the cured material forms a ceramic char at a heat flux of about 100 W/cm² or greater.

In one embodiment in accordance with any previous embodiment, the cured material forms a ceramic char at a heat flux of about 200 W/cm².

In one embodiment in accordance with any previous embodiment, the cured material forms a ceramic char at a heat flux of from about 20 W/cm² to about 1500 W/cm².

In one embodiment in accordance with any previous embodiment, the cured material forms a ceramic char at a heat flux of from about 20 W/cm² to about 100 W/cm².

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a graph showing the heat soak temperatures of various examples descried in the application;

FIG. 2 is a graph showing peak surface temperatures of various examples descried in the application;

FIG. 3 is a graph showing recession of various examples descried in the application;

FIG. 4 is a graph showing recession of various examples descried in the application;

FIG. 5 is a graph showing mass loss of various examples descried in the application;

FIG. 6 is a graph showing mass loss of various examples descried in the application;

FIG. 7 is a graph showing mass loss over multiple heat fluxes of various examples descried in the application;

FIG. 8 is a graph showing recession over multiple heat fluxes of various examples descried in the application;

FIG. 9 is a graph showing heat soak temperatures over multiple heat fluxes of various examples descried in the application;

FIG. 10 are photos showing the degree of cracking of various examples descried in the application; and

FIG. 11 is a graph showing the peel strength of various examples descried in the application.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that where ranges of a particular component are given the numerical values may be combined to form new and non-specified ranges, including, for example, from a combination of lower and/or upper end-points of different ranges.

Where multiple possible ranges are shown for components, it will be appreciated that any range of a component may be used with any other range of another component in the composition.

The term “hydrocarbon” or “hydrocarbon radical” means any hydrocarbon from which one or more hydrogen atoms has been removed and is inclusive of alkyl, alkenyl, alkynyl, cyclic alkyl, cyclic alkenyl, cyclic alkynyl, aryl, aralkyl and arenyl and may contain heteroatoms.

The term “alkyl” means any monovalent, saturated straight, branched, or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include, but are not limited to, methyl, ethyl, propyl and isobutyl. Examples of alkenyls include, but are not limited to, vinyl, propenyl, allyl, methallyl, ethylidenyl norbornane, ethylidene norbornyl, ethylidenyl norbornene and ethylidene norbornenyl. Examples of alkynyls include, but are not limited to, acetylenyl, propargyl and methylacetylenyl.

The term “cyclic alkyl,” “cyclic alkenyl,” and “cyclic alkynyl” include bicyclic, tricyclic, and higher cyclic structures as well as the aforementioned cyclic structures further substituted with alkyl, alkenyl, and/or alkynyl groups. Examples include, but are not limited to, norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “alkaryl” means any aryl group (as defined herein) in which one or more hydrogen atoms have been substituted by the same number of like and/or different alkyl groups (as defined herein). Examples of aryls include, but are not limited to, phenyl and naphthalenyl. Examples of aralkyls include, but are not limited to, benzyl and phenethyl. Examples of alkaryl include, but are not limited to, tolyl and xylyl.

The term “heteroatom” means any of the Group 13-17 elements except carbon. Examples of heteroatoms include, but are not limited to, oxygen, nitrogen, silicon, sulfur, phosphorus, fluorine, chlorine, bromine and iodine.

The terms “polymer” and “resin” or “polymer resin” as used herein are used interchangeably with one another.

Provided is silicone composition. The silicone composition is suitable for use as a coating to provide thermal insulation to an underlying substrate or article. Upon exposure to extremely high temperatures, the silicone composition or a coating formed therefrom forms a ceramic char, which acts as an insulating material to limit the transfer of heat to the underlying surfaces.

The silicone composition comprises a silicone resin, a catalyst to promote curing of the resin, one or more char-forming fillers, a phenyl substituted cyclic siloxane, and optionally an alkenyl functional organopolysiloxane.

The silicone resin may be provided by any suitable silicone material that, upon curing, forms a crosslinked material. The silicone resin can be provided by an addition curable composition or a condensation curable composition.

Silicone rubber (a) can be obtained by curing any one of numerous known curable silicone rubber-forming compositions, e.g., liquid silicone rubber (LSR) compositions, room temperature vulcanizable silicone rubber (RTV) compositions and heat curable silicone elastomer (HCE) compositions.

A typical LSR composition is a multi-component combination of a vinyl-containing polydiorgansiloxane fluid, a hydrogen-containing polydiorganosiloxane fluid, an effective amount of a catalyst a. Typically, two-component LSR mixtures are mixed and charged into a preheated mold where they are rapidly cured to produce a silicone rubber article. A first component, or package, includes a vinyl-containing polydiorgansiloxane fluid, a silica filler and an effective amount of a platinum catalyst and a second component, or package, includes a hydrogen-containing polydiorganosiloxane fluid in combination with other ingredients including a vinyl-containing polyorganosiloxane fluid and a silica filler. Typically, the LSR composition is produced by kneading a polydiorganosiloxane, inorganic filler and additives by means of a kneading machine such as a Banbury mixer, a turbulizer, a change can mixer or a low intensity double arm dough mixer. In this process, polydiorganosiloxane, inorganic filler, treating agents and additives are batch mixed until the desired properties are obtained. The batch mixing process can take 12 to 30 hours per batch. After mixing, the LSR composition is stripped of volatiles and cooled. For additional details regarding LSRs and silicone rubbers obtained therefrom, reference may be made, inter alia, to U.S. Pat. No. 6,444,154, the entire contents of which are incorporated by reference herein.

RTV silicone compositions may be formulated as one-component or two-component systems. A common form of one-component RTV silicone, curable by exposure to moisture, includes an organosiloxane polymer possessing terminal hydroxyl groups, a polyfunctional organosilicone cross-linking agent and a crosslinking catalyst, e.g., as disclosed in U.S. Pat. Nos. 4,100,129, 4,593,085, 5,420,196, 5,932,650 and 6,737,494, the entire contents of which are incorporated by reference herein. Two-component RTV silicone systems typically comprise an “A” package containing a dihydroxy or silanol-terminated polydiorganosiloxane, a semi-reinforcing filler such as calcium carbonate or ground quartz, a reinforcing filler such as fumed silica and water and a “B” package containing a T or Q functional crosslinker and a condensation cure catalyst, e.g., as disclosed in U.S. Pat. No. 4,490,500, the entire of contents of which are incorporated by reference herein.

In embodiments, the silicone resin comprises an MQ silicone resin. The MQ silicone resin may be provided as a two-part system comprising a alkenyl-functional MQ resin, and a hydride-functional MQ resin that cure via a hydrosilylation reaction to form a crosslinked material.

The MQ resin may comprise an alkenyl-functional MQ resin. The alkenyl-functional MQ resin comprises may be designated herein as M1Q1 resin comprising R¹(R²)₂SiO_{1/2} (“M¹”) units, (R³)₃SiO_{1/2} (“M²”) units, and SiO_{4/2}(“Q¹”) units, where R¹ is a C2-C12 alkenyl group, and R² and R³ are each independently a C1-C10 alkyl group. In embodiments, R¹ is a C2-C12 alkenyl group, a C3-C10 alkenyl group, or a C4-C8 alkenyl group. In one embodiment, R¹ is a C2 alkenyl or a C3 alkenyl. In one embodiment, R¹ is a C2 alkenyl. In embodiments, R² and R³ are selected from a C1-C10 alkyl group, a C2-C8 alkyl group, or a C4-C6 alkyl group. In embodiments, R² and R³ are each methyl.

It will be appreciated that the MQ resins may include D and/or T units. In one embodiment, the MQ resin comprises R⁴_{y}(R⁵)_{2-y}SiO_{2/2} (“D¹”) where R⁴ is an C2-C12 alkenyl group, R⁵ is a C1-C10 alkyl group, and y is 0 or 1. In embodiments, R⁴ is a C2-C12 alkenyl group, a C3-C10 alkenyl group, or a C4-C8 alkenyl group. In one embodiment, R⁴ is a C2 alkenyl or a C3 alkenyl. In one embodiment, R⁴ is a C2 alkenyl. In embodiments, R⁵ is selected from a C1-C10 alkyl group, a C2-C8 alkyl group, or a C4-C6 alkyl group. In embodiments, R⁵ is methyl. In one embodiment, the MQ resin comprises D¹ units where y is 1, and the D¹ unit is an alkenyl-functional group.

In one embodiment, the MQ resin comprises R⁶SiO_{3/2} (“T¹”) units where R⁶ is selected from a C1-C10 alkyl group or a C2-C12 alkenyl group. In one embodiment R⁶ is selected from a C2-C12 alkenyl group. In embodiments where R⁶ is an alkyl group, R⁶ is selected from a C1-C10 alkyl group, a C2-C8 alkyl group, or a C4-C6 alkyl group. In embodiments, R⁶ is methyl.

The MQ resin may generally comprise M¹ units in an amount of from about 5% to about 60%, from about 10% to about 50%, or from about from about 20% to about 40% by weight of the alkenyl-functional MQ resin, M² units in an amount of from about 1% to about 10%, from about 2% to about 8%, or from about 4% to about 6% by weight of the alkenyl functional MQ resin, and Q¹ units in an amount of from about 20% to about 95%, from about 30% to about 90%, or from about 50% to about 80% by weight of the alkenyl functional MQ resin.

Where the alkenyl-functional MQ resin comprises D and/or T units, the D¹ units may be present in an amount of from about 0% to about 10%, from about 5% to about 8%, or from about 1% to about 4% by weight of the alkenyl-functional MQ resin, and the T1 units may be present in an amount of from about 0% to about 4%, from about 3% to about 20%, or from about 14% to about 30% by weight of the alkenyl-functional MQ resin all determined by ²⁹Si NMR.

The alkenyl-functional MQ resin has a viscosity of from about 1,000 cP to being a solid, from about 500 cP to about 1,000,000 cP, from about 1,000 cP to about 750,000 cP, from about 2,500 cP to about 500,000 cP, from about 5,000 cP to about 250,000 cP, from about 10,000 cP to about 100,000 cP, from about 20,000 cP to about 75,000 cP, or from about 30,000 cP to about 50,000 cP. In one embodiment the alkenyl-functional MQ resin has a viscosity of from about 15,000 cP to about 1,000,000 cP. Viscosity is determined by a DVPlus Brookfield viscometer.

The MQ resin may comprise a hydride-functional MQ resin. The hydride-functional MQ resin comprises R⁷(R⁸)₂SiO_{1/2} (“M³”) units, (R⁹)₃SiO_{1/2} (“M⁴”) units, and SiO₄/2 (“Q²”) units, where R⁷ is hydrogen, and R⁸ and R⁹ are each independently a C1-C10 alkyl group. In embodiments, R⁸ and R⁹ are selected from a C1-C10 alkyl group, a C2-C8 alkyl group, or a C4-C6 alkyl group. In embodiments, R⁸ and R⁹ are each methyl.

It will be appreciated that the hydride-functional MQ resins may include D and/or T units. In one embodiment, the hydride-functional MQ resin comprises R¹⁰ₓ(R¹¹)₂₋ₓSiO_{2/2} (“D²”) where R¹⁰ is hydrogen, R¹¹ is a C1-C10 alkyl group, and x is 0 or 1. In embodiments, R¹¹ is selected from a C1-C10 alkyl group, a C2-C8 alkyl group, or a C4-C6 alkyl group. In embodiments, R¹¹ is methyl. In one embodiment, the MQ resin comprises D² units where y is 1, and the D¹ unit is an alkenyl functional group.

In one embodiment, the hydride-functional MQ resin comprises R¹²SiO_{3/2} (“T²”) units where R¹² is selected from a C1-C10 alkyl group or hydrogen. In one embodiment R¹² is selected from hydrogen. In embodiments where R¹² is an alkyl group, R¹² is selected from a C1-C10 alkyl group, a C2-C8 alkyl group, or a C4-C6 alkyl group. In embodiments, R¹² is methyl.

The hydride-functional MQ resin may generally comprise M³ units in an amount of from about 5% to about 70%, from about 10% to about 40%, or from about from about 20% to about 65% by weight of the hydride-functional MQ resin, M⁴ units in an amount of from about 5% to about 70%, from about 10% to about 40%, or from about 20% to about 65% by weight of the hydride-functional MQ resin, and Q² units in an amount of from about 5% to about 50%, from about 10% to about 40%, or from about 20% to about 30%.

Where the hydride-functional MQ resin comprises D and/or T units, the D² units may be present in an amount of from about 0% to about 20%, from about 2% to about 6%, or from about 10% to about 20% by weight of the hydride-functional MQ resin, and the T² units may be present in an amount of from about 0% to about 10%, from about 2% to about 6%, or from about 10% to about 20% by weight of the hydride-functional MQ resin.

The hydride-functional MQ resin has a viscosity of from about 5 cSt to about 300 cSt, from about 500 cP to about 20,000 cP, from about 1,000 cP to about 15,000 cP, from about 1,500 cP to about 12,000 cP, or from about 2,500 cP to about 10,000 cP. In one embodiment, the hydride-functional MQ resin has a viscosity of from about 10,000 cP to about 15,000 cP. Viscosity is determined by either an Oswald viscometer tube or DVPlus Brookfield viscometer.

In the composition the alkenyl-functional silicone resin may be present in an amount of from about 30% to about 70% by weight of the composition, from about 35% to about 60% by weight of the composition, or from about 40% to about 50% by weight of the composition. The hydride-functional silicone resin may be present in an amount of from about 2% to about 15% by weight of the composition, from about 5% to about 12% by weight of the composition, or from about 7% to about 10% by weight of the composition.

The catalyst may be selected as desired for curing the silicone resin. In embodiments where the silicone resin cures via hydrosilylation (e.g., via the reaction of silicone hydride and an alkenyl-functional silicone), examples of suitable catalysts include, but are not limited to, precious metal catalysts such as those which use ruthenium, rhodium, palladium, osmium, iridium, and platinum, and complexes of these metals. In one embodiment, the catalyst is selected from a platinum-based catalyst. Particularly suitable hydrosilylation catalysts include, but are not limited to, Ashby catalysts; Lamoureux catalysts; Karstedt catalysts; Modic catalysts; and Jeram catalysts and combinations thereof.

The catalyst can be present in an amount of from about 0.01 to about 10% by weight, from about 0.1% to about 8% by weight, or from about 0.5% to about 5% by weight of the composition.

In one embodiment, the silicone composition is a condensation cure type comprising an organopolysiloxane component capped with a hydroxyl or hydrolyzable group at an end of its molecular chain, a silane having at least three silicon-bonded hydrolyzable groups in a molecule or a partial hydrolytic condensate thereof, and a condensation catalyst.

The organopolysiloxane component capped with a hydroxyl or hydrolyzable group at an end of its molecular chain may be linear or a structure having a branched chain as long as it has two or more alkoxy groups bonded to silicon atoms in a molecule and a viscosity of 3 mPa·s to 500 mPa·s. The linear polyorganosiloxane is preferable because the viscosity is easily set to the above-described range. Note that in the case of using the branched polyorganosiloxane, it is preferably used in combination with the linear polyorganosiloxane in order to maintain the viscosity as the whole of the component.

The viscosity of the component is 3 Pa·s to 500 Pa·s. When the viscosity of the component is less than 3 Pa·s, a cured product to be obtained becomes poor in rubber elastic, whereas when it exceeds 500 Pa·s, the workability when fabricating a cured product such as a cured coating film decreases. Further, when the viscosity of the component exceeds 500 Pa·s, the compatibility with a branched polyorganosiloxane is poor, resulting in failure to obtain a uniform composition.

The condensation catalyst is a component for accelerating a hydrolysis condensation of the above-mentioned condensation cure composition. As the condensation catalyst, for example, a metal catalyst, an organic acid catalyst, an inorganic acid catalyst, or a base catalyst can be used. From the viewpoint of the curing rate of the composition, the condensation catalyst is preferably a metal catalyst.

With respect to the metal atom contained in the metal catalyst, for example, there can be mentioned titanium, zirconium, and tin. Particularly, an organotin compound or an alkoxytitanium is preferred. As one mode of the metal catalyst, a compound having an alkoxide as a ligand, preferably an alkoxide having 1 to 4 carbon atoms, further preferably having 1 to 3 carbon atoms, can be used. When using such a catalyst, the catalyst is easily dissolved or dispersed in the curable composition to contribute to acceleration of a uniform condensation reaction.

Examples of preferred metal catalysts include organic titanium chelate compounds such as ethyl acetoacetonate titanate, titanium diisopropoxybis(ethylacetoacetate) and titanium diisopropoxybis(ethylacetoacetate); organic titanates such as tetrabutyl titanate and tetraisopropyl titanate; organoaluminum compounds such as tris(acetylacetonato)aluminum and tris(ethylacetoacetato)aluminum; organozirconium compounds such as tetra(acetylacetonato)zirconium and zirconium tetrabutyrate; organotin compounds such as dibutyl tin dioctoate, dibutyl tin dilaurate and dibutyl tin di(2-ethylhexanoate).

Other condensation catalysts may include metal salts of organic carboxylic acids such as tin naphthenate, tin oleate, tin butyrate, cobalt naphthenate, and zinc stearate; amine compounds such as hexylamine and dodecylamine phosphate; quaternary ammonium salts such as benzyltriethylammonium acetate; alkali metal salts of lower fatty acids such as potassium acetate and lithium nitrate; dialkylhydroxylamines such as dimethylhydroxylamine and diethylhydroxylamine; guanidyl-containing organosilicon compounds carbonic acid metal salts, such as iron octoate, manganese octoate, zinc octoate, tin naphthate, tin caprylate, and tin oleate; organotin compounds, such as dibutyltin diacetate, dibutyltin dioctoate, dibutyltin dilaurate, dibutyltin dioleate, diphenyltin diacetate, dibutyltin oxide, dibutyltin dimethoxide, dibutylbis(triethoxysiloxy)tin, dioctyltin dilaurate, and dimethyltin dineodecanoate; organotitaniums, such as tetraethoxytitanium, tetrapropoxytitanium, tetraisopropoxytitanium, tetra-n-butoxytitanium, tetraisobutoxytitaniuin, diisopropoxytitanium bis(ethylacetoacetate), and 1,3-propanedioxytitanium bis(ethylacetoacetate); organoaluminums, such as aluminum trisacetylacetonate, aluminum trisethylacetoacetate, diisopropylaluminum ethylacetoacetate, and triethoxyaluminum; and organozirconium compounds, such as zirconium tetraacetylacetonate, tetraisopropoxyzirconium, tetrapropoxyzirconium, tetra-n-butoxyzirconium, tetraisobutoxyzirconium, tributoxyzirconium acetylacetonate, and tributoxyzirconium stearate.

With respect to the organic acid catalyst, for example, there can be mentioned compounds having a carboxylic acid, sulfonic acid, or phosphoric acid, and specific examples include acetic acid, trifluoroacetic acid, methanesulfonic acid, toluenesulfonic acid, and an alkylphosphoric acid. With respect to the inorganic acid catalyst, for example, there can be mentioned hydrochloric acid and sulfuric acid.

Examples of the base catalysts include amine compounds, such as ammonia, trietylamine, and diethylamine, dialkylhydroxyamines, such as dimethylhydroxyamine and diethylhydroxyamine, and guanidyl compounds, such as tetramethylguanidine and guanidyl group-containing silane or siloxane.

In the curable composition of the present invention, the condensation catalyst is preferably contained in an amount of 0.01 to 20.0 parts by mass, more preferably 0.1 to 5.0 parts by mass, relative to 100 parts by mass of siloxane polymer.

### Ceramic Fillers

The composition comprises ceramic fillers or materials that will form a ceramic char upon exposure to extreme temperatures. In one embodiment, the ceramic filler is selected from mullite. Mullite refers to a subset of crystalline aluminosilicates. Mullite can be represented by the stoichiometric forms 3Al₂O₃·2SiO₂ and 2Al₂O₃·SiO₂, or more generally as Al₂[Al_{2+2z}Si_{2-2z}]O₁₀₋ₓ where 0.18≤z≤0.88. As is known in the art, mullite can be identified by x-ray diffraction, and standard x-ray diffraction patterns for mullite are well known.

The mullite material can be provided in any suitable form as may be desired or suitable for use in the composition. The mullite material can have a platelet shape, a needle shape, or mixtures thereof.

In embodiments, the crystallite size, as determined by the isolated (001) x-ray diffraction peak (which may correspond to a longer dimension of the crystal), is at least 50 nm, at least 55 nm, at least 60 nm, or even at least 65 nm. In embodiments, the crystallite size, as determined by the isolated (001) x-ray diffraction peak, is at most 1000 nm, at most 700 nm, at most 400 nm, at most 200 nm, at most 150 nm, at most 100 nm, at most 90 nm, and in other embodiments at most 85 nm. In embodiments, the average crystallite size, as determined by the isolated (001) x-ray diffraction peak, is from about 50 nm to about 100 nm, from about 55 nm to about 90 nm, or from about 60 nm to about 85 nm. In some instances, the upper limit for determination of crystallite size is 100 nm for some instrumentation, but scanning electron micrographs can be utilized to corroborate crystallite dimensions greater than 100 nm.

In embodiments, the aspect ratio of the mullite crystallites, which refers to the ratio of the mullite crystallite size by the isolated (001) x-ray diffraction peak to the mullite crystallite size by the isolated (110) x-ray diffraction peak (i.e. the longest dimension to the shortest dimension) may be at least 1.5, at least 1.6, at least 1.7 at least 1.8, at least 1.9, or at least 2.0.

The mullite may be present in the composition in an amount of from about 5% to about 50% by weight, from about 8% to about 45% by weight, from about 10% to about 40% by weight, from about 15% to about 35% by weight, or from about 20% to about 30% by weight based on the total weight of the composition.

In addition to the mullite, the composition may comprise alumina, silica, aluminosilicates, or mixtures of two or more thereof. Without being bound to any particular theory, the non-mullite fillers such as alumina, silica, and/or aluminosilicates may be converted to mullite in the composition upon exposure to high temperatures. These materials may allow for a cascading series of reactions as the temperature increases to convert such materials to mullite. In particular the various forms of the aluminosilicates are converted to different forms at different temperatures, and to various forms of mullite above 1050° C. Examples of suitable aluminosilicates include, but are not limited to, kaolin (Al₂Si₂O₅(OH)₄), metakaolin (Al₂Si₂O₇), spinel (Si₃Al₄O₁₂), and the like.

The additional alumina, silica, and/or aluminosilicates can be independently provided in an amount of from about 0.1% to about 5% by weight, from about 0.5% to about 4% by weight, from about 0.7% to about 3% by weight or from about 1% to about 2% by weight based on the weight of the composition.

In one embodiment, the composition comprises alumina and silica, where the alumina is present in an amount of from about 0.1% to about 2% by weight, from about 0.5% to about 1.5% by weight, or from about 0.75% to about 1% by weight based on the total weight of the composition, and the silica is present in an amount of from about 0.5% by weight to about 5% by weight, from about 1% to about 4% by weight, or from about 2% to about 3% by weight based on the total weight of the composition.

The composition may comprise other additional fillers including, but not limited to, titanium diboride, calcium carbonate, diatomaceous earth, zinc oxide, iron oxide, carbon fibers, carbon black, boric anhydride, silicon carbide, aluminum powder. Without being bound to any particular theory, one or more of the additional fillers may be selected to effectively lowering the thermal diffusivity of the composition and to help block heat from diffusing through the material to the underlying substrate. In particular one or more of these additional fillers may undergo one or more reactions during exposure to elevated temperatures to produce a compound that is effective in blocking heat transfer through the material.
Silica can react with carbon to form silicon carbide and carbon monoxide. Silicon carbide has a low heat diffusivity to help block the transfer of heat through the material, and carbon monoxide that evolves in such reactions can pass through the pores of the material to “push back” on the heat source.
Aluminum powder can turn to a liquid at elevated temperatures and subsequently react with the carbon to form aluminum carbide.
Boric anhydride can change from solid to liquid and to a gas at elevated temperatures.

The additional fillers, if present, can be present in an amount of from about 1% to about 35% by weight, from about 2% to about 30% by weight, from about 4% to about 25% by weight, from about 5% to about 20% by weight, or from about 10% by weight to about 15% by weight based on the total weight of the composition. In embodiments, the additional fillers may be present in an amount of from about 1% to about 10% by weight, from about 2% to about 8% by weight, or from about 4% to about 6% by weight based on the total weight of the composition.

The composition may optionally comprise an alkyl and/or aryl substituted cyclosiloxanes. The alkyl and/or aryl substituted cyclosiloxanes may be used in the composition in place of carbon black. Without being bound to any particular theory, the alkyl/aryl groups are pyrolyzed and converted to carbon when exposed to elevated temperatures. This allows for providing a source of carbon while controlling the ratio of silicon to carbon by introducing this via the siloxane material.

Examples of such substituted cyclosiloxanes include but are not limited to include 2,2,4,4,6,6-hexamethylcyclotrisiloxane, 2,4,6-triethyl-2,4,6-trimethylcyclotrisiloxane, 2,2,4,4,6,6-hexaethylcyclotrisiloxane, 2,4,6-trimethyl-2,4,6-tripropylcyclotrisiloxane, 2,4,6-triethyl-2,4,6-tripropylcyclotrisiloxane, 2,2,4,4,6,6-hexapropylcyclotrisiloxane, 2,4,6-trimethyl-2,4,6-tris(1-methylethyl)cyclotrisiloxane, 2,4,6-triethyl-2,4,6-tris(1-methylethyl)cyclotrisiloxane 2,2,4,4,6,6-hexakis(1-methylethyl)cyclotrisiloxane, 2,4,6-tributyl-2,4,6-trimethylcyclotrisiloxane, 2,4,6-tributyl-2,4,6-triethylcyclotrisiloxane, 2,2,4,4,6,6-hexabutylcyclotrisiloxane, 2,4,6-trimethyl-2,4,6-tris(1,1-dimethylethyl)cyclotrisiloxane, 2,4,6-triethyl-2,4,6-tris(1,1-dimethylethyl)cyclotrisiloxane, 2,4,6-tris(1,1-dimethylethyl)-2,4,6-tripropylcyclotrisiloxane, 2,2,4,4,6,6-hexakis(1,1-dimethylethyl)cyclotrisiloxane, 2,4,6-trimethyl-2,4,6-tris(trifluoromethyl)cyclotrisiloxane, 2,2,4,4,6,6-hexakis(trifluoromethyl)cyclotrisiloxane, 2,2,4,4,6,6-hexakis(1,1,2,2,2-pentafluoroethyl)cyclotrisiloxane, 2,4,6-trimethyl-2,4,6-tris(3,3,3-trifluoropropyl)cyclotrisiloxane, 2,2,4,4,6,6-hexakis(3,3,3-trifluoropropyl)cyclotrisiloxane, 2,4,6-trimethyl-2,4,6-triphenylcyclotrisiloxane, 2,2,4,4,6,6-hexaphenylcyclotrisiloxane, 2,4,6-tricyclohexyl-2,4,6-trimethylcyclotrisiloxane, 2,2,4,4,6,6-hexacyclohexylcyclotrisiloxane, 2,2,4,4,6,6,8,8-octamethylcyclotetrasiloxane, 2,4,6,8-tetraethyl-2,4,6,8-tetramethylcyclotetrasiloxane, 2,2,4,4,6,6,8,8-octaethylcyclotrisiloxane, 2,4,6,8-tetramethyl-2,4,6,8-tetrapropylcyclotetrasiloxane, 2,4,6,8-tetraethyl-2,4,6,8-Tetrapropylcyclotetrasiloxane, 2,2,4,4,6,6,8,8-octapropylcyclotetrasiloxane, 2,4,6,8-tetramethyl-2,4,6,8-tetrakis(1-methylethyl)cyclotetrasiloxane, 2,4,6,8-tetraethyl-2,4,6,8-tetrakis(1-methylethyl)cyclotetrasiloxane 2,2,4,4,6,6,8,8-octakis(1-methylethyl)cyclotetrasiloxane, 2,4,6,8-tetrabutyl-2,4,6,8-tetramethylcyclotetrasiloxane, 2,4,6,8-tetrabutyl-2,4,6,8-tetraethylcyclotetrasiloxane, 2,2,4,4,6,6,8,8-octabutylcyclotetrasiloxane, 2,4,6,8-tetramethyl-2,4,6,8-tetrakis(1,1-dimethylethyl)cyclotetrasiloxane, 2,4,6,8-tetraethyl-2,4,6,8-tetrakis(1,1-dimethylethyl)cyclotetrasiloxane, 2,4,6,8-tetrakis(1,1-dimethylethyl)-2,4,6,8-tetrapropylcyclotetrasiloxane, 2,2,4,4,6,6,8,8-octakis(1,1-dimethylethyl)cyclotetrasiloxane, 2,4,6,8-tetramethyl-2,4,6,8-tetrakis(trifluoromethyl)cyclotetrasiloxane, 2,2,4,4,6,6,8,8-octakis(trifluoromethyl)cyclotetrasiloxane, 2,2,4,4,6,6,8,8-octakis(1,1,2,2,2-pentafluoroethyl)cyclotetrasiloxane, 2,4,6,8-tetramethyl-2,4,6,8-tetrakis(3,3,3-trifluoropropyl)cyclotetrasiloxane, 2,2,4,4,6,6,8,8-octakis(3,3,3-trifluoropropyl)cyclotetrasiloxane, 2,4,6,8-tetramethyl-2,4,6,8-tetraphenylcyclotetrasiloxane, 2,2,4,4,6,6,8,8-octaphenylcyclotetrasiloxane, 2,4,6,8-tetracyclohexyl-2,4,6,8-tetramethylcyclotetrasiloxane, 2,2,4,4,6,6,8,8-octacyclohexylcyclotetrasiloxane, 2,2,4,4,6,6,8,8,10,10-decamethylcyclopentasiloxane, 2,4,6,8,10-pentaethyl-2,4,6,8,10-pentamethylcyclopentasiloxane, 2,2,4,4,6,6,8,8,10,10-decaethylcyclotrisiloxane, 2,4,6,8,10-pentamethyl-2,4,6,8-pentapropylcyclopentasiloxane, 2,4,6,8,10-pentaethyl-2,4,6,8,10-pentapropylcyclopentasiloxane, 2,2,4,4,6,6,8,8,10,10-decapropylcyclopentasiloxane, 2,4,6,8,10-pentamethyl-2,4,6,8,10-pentakis(1-methylethyl)cyclopentasiloxane, 2,4,6,8,10-pentaethyl-2,4,6,8,10-pentakis(1-methylethyl)cyclopentasiloxane 2,2,4,4,6,6,8,8,10,10-decakis(1-methylethyl)cyclopentasiloxane, 2,4,6,8,10-pentabutyl-2,4,6,8,10-pentamethylcyclopentasiloxane, 2,4,6,8,10-pentabutyl-2,4,6,8,10-pentaethylcyclopentasiloxane, 2,2,4,4,6,6,8,8,10,10-decabutylcyclopentasiloxane, 2,4,6,8,10,10-pentamethyl-2,4,6,8,10,10-pentakis(1,1-dimethylethyl)cyclopentasiloxane, 2,4,6,8,10-pentaethyl-2,4,6,8,10-pentakis(1,1-dimethylethyl)cyclopentasiloxane, 2,4,6,8,10-pentakis(1,1)-dimethylethyl)-2,4,6,8,10-pentapropylcyclopentasiloxane, 2,2,4,4,6,6,8,8,10,10-decakis(1,1-dimethylethyl)cyclopentasiloxane, 2,4,6,8,10-pentamethyl-2,4,6,8-pentakis(trifluoromethyl)cyclopentasiloxane, 2,2,4,4,6,6,8,8,10,10-decakis(trifluoromethyl)cyclopentasiloxane, 2,2,4,4,6,6,8,8,10,10-decakis(1,1,2,2,2-pentafluoroethyl)cyclopentasiloxane, 2,4,6,8,10,10-pentamethyl-2,4,6,8-pentakis(3,3,3-trifluoropropyl)cyclopentasiloxane, 2,2,4,4,6,6,8,8,10,10-decakis(3,3,3-trifluoropropyl)cyclopentasiloxane, 2,4,6,8,10-pentamethyl-2,4,6,8-pentaphenylcyclopentasiloxane, 2,2,4,4,6,6,8,8,10,10-decaphenylcyclopentasiloxane, 2,4,6,8,10-pentacyclohexyl-2,4,6,8,10-pentamethylcyclopentasiloxane, and 2,2,4,4,6,6,8,8,10,10-decacyclohexylcyclopentasiloxane. In one embodiment, the phenyl substituted cyclosiloxanes is selected from octaphenyl cyclotetrasiloxane, hexaphenyl cyclotrisiloxane, or a combination thereof.

The alkyl/aryl substituted cyclosiloxnae may be present in an amount of from about 0.5% to about 10%, from about 2.5% to about 7.5%, or from about 7.0% to about 10% by weight based on the total weight of the composition.

The composition may further comprise an alkenyl-functional organopolysiloxane. The selection and inclusion of an alkenyl-functional organopolysiloxane may help to control properties of the material such as the softness of the material, the recession (erosion) of the material, and the like.

In one embodiment, the alkenyl-functional organopolysiloxane is selected from a compound of the formula:

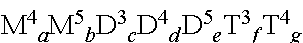

where
M⁴ is (R¹³)₃SiO_{1/2}
M⁵ is R¹⁴(R¹⁵)₂SiO_{1/2}
D³ is (R¹⁶)₂SiO_{2/2}
D⁴ is (R¹⁷)(R¹⁸)SiO_{2/2}
D⁵ is (R¹⁹)₂SiO_{2/2}
T³ is R²⁰SiO_{3/2}
T⁴ is R²¹SiO_{3/2}
R¹³, R¹⁵, R¹⁶, and R¹⁷ are independently selected from a C1-C10 alkyl group,
R¹⁹ is selected from a C6-C30 aryl group,
R¹⁴, R¹⁸, and R²⁰ are independently selected from a C2-C12 alkenyl functional group,
R²¹ is selected from a C1-C10 alkyl group or a C6-C30 aryl group, a, b, c, d, e, f, and g are independently 0 to 100, where a+b+c+d+e+f+g is from 250 to 10,000, and at least one of b, d, and f is greater than 0.

In one embodiment, the alkenyl functional organopolysiloxane is of the formula:

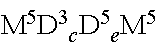

where M⁵ is R¹⁴(R¹⁵)₂SiO_{1/2}, D³ is (R¹⁶)₂SiO_{2/2}, D⁵ is (R¹⁹)₂SiO_{2/2}, and R¹⁴, R¹⁵, R¹⁶, and R¹⁹, and subscripts c and e are as described above. In embodiments R¹⁵ and R¹⁶ are methyl, R¹⁴ is a C2 alkenyl group, and R¹⁹ is phenyl.

Such alkenyl-functional organopolysiloxanes may be employed to provide a softer material.

In one embodiment, the alkenyl-functional organopolysiloxane is selected from a siloxane-imide polymer. In embodiments, the alkenyl-functional siloxane imide polymer is a compound of the formula (I):

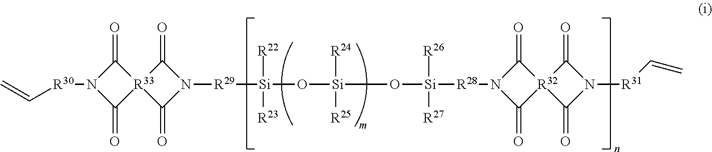

R²², R²³, R²⁴, R²⁵, R²⁶, and R²⁷ are each independently selected from a C1-C10 alkyl and a C6-C20 aryl;
R²⁸ and R²⁹ are independently selected from a divalent C2-C10 alkyl and a divalent C6-C20 aryl-containing groups.
R³⁰ and R³¹ are independently selected from a bond a C1-C20 divalent hydrocarbon, a C4-C20 branched divalent hydrocarbon, or a C4-C30 cyclic containing hydrocarbon group;
R³² and R³³ are independently chosen from a C5-C20 aryl, a polycyclic aryl group comprising two or more C5-C20 aryl groups, where R³² and R³³ can be unsubstituted or substituted with a C1-C6 alkyl, a halogen, a haloalkyl, a hydroxy, and/or a C1-C5 alkoxy groups;
m is an integer from 1 to about 200; and
n is an integer from 1 to about 30.

R²², R²³, R²⁴, R²⁵, R²⁶, and R²⁷ are each independently selected from a C1-C10 alkyl and a C6-C20 aryl. In embodiments, R²², R²³, R²⁴, R²⁵, R²⁶, and R²⁷ are selected from a C1-C10 alkyl, a C2-C8 alkyl, or a C4-C6 alkyl. In one embodiment R²², R²³, R²⁴, R²⁵, R²⁶, and R²⁷ are each methyl.

R³⁰ and R³¹ are independently selected from a bond, a C1-C20 divalent hydrocarbon, a C4-C20 branched divalent hydrocarbon, or a C4-C30 cyclic containing hydrocarbon group. In embodiments, R³⁰ and R³¹ are independently selected from a C1-C20 divalent hydrocarbon, a C2-C15 hydrocarbon, a C3-C10 divalent hydrocarbon, or a C4-C6 divalent hydrocarbon. In one embodiment, R³⁰ and R³¹ are independently a C1 divalent hydrocarbon (i.e., and methylene group). In one embodiment, R³⁰ and R³¹ are selected from a C6-C30 aryl-containing group.

R³² and R³³ is selected from a C5-C20 aryl, or polycyclic aryl comprising two or more C5-C20 aryl groups. The polycyclic aryl groups can be a fused ring, or an unfused system joined by a linker group. Examples of suitable aryl and/or polycyclic aryl groups for R³² and R³³ include, but are not limited to, benzene, naphthalene, benzophenone, biphenyl, a biphenyl alkane (e.g., a biphenyl group with an alkyl linker chosen from a C1-C20 alkyl such as, but not limited to, biphenyl methane, biphenyl ethane, biphenyl propane, biphenyl isopropane, biphenyl butane, biphenyl isobutene, biphenyl tertbutane, biphenyl hexane, biphenyl octane, etc.) biphenylether, isopropylidinediphenylphenoxy, biphenyl sulfone, biphenylsulfide, norbornyl and hexafluoromethylbiphenyl, etc. In one embodiment, R³² and R³³ are each benzene.

In one embodiment, m is an integer of from 1 to about 200, from about 5 to about 175, from about 10 to about 150, from about 25 to about 135, from about 50 to about 110, or from about 75 to about 100.

In one embodiment, n is an integer of from about 1 to about 30, from about 2 to about 25, from about 5 to about 20, or from about 10 to about 15. In one embodiment, n is 1.

In another embodiment, the alkenyl-functional siloxane imide polymer may be a compound of the formula (II):

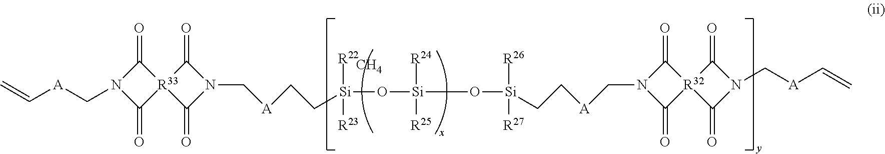

where
R³⁴ and R³⁵ are independently chosen from a C5-C20 aryl, a polycyclic aryl group comprising two or more C5-C20 aryl groups, where R³⁴ and R³⁵ can be unsubstituted or substituted with a C1-C6 alkyl, a halogen, a haloalkyl, a hydroxy, and/or a C1-C5 alkoxy groups;
A may be chosen from C5-C20 aryl;
R³⁶, R³⁷, R³⁸, R³⁹, R⁴⁰, and R⁴¹ may be same or different and can be chosen from C1-C10 alkyl and C6-C20 aryl;
x is an integer from 1 to about 200; and
y is an integer from 1 to about 30.

R³⁴ and R³⁵ are independently selected from a C5-C20 aryl, or polycyclic aryl comprising two or more C5-C20 aryl groups. The polycyclic aryl groups can be a fused ring or an unfused system joined by a linker group. Examples of suitable aryl and/or polycyclic aryl groups for R¹ include, but are not limited to, benzene, naphthalene, benzophenone, biphenyl, a biphenyl alkane (e.g., a biphenyl group with an alkyl linker chosen from a C1-C20 alkyl such as, but not limited to, biphenyl methane, biphenyl ethane, biphenyl propane, biphenyl isopropane, biphenyl butane, biphenyl isobutene, biphenyl tertbutane, biphenyl hexane, biphenyl octane, etc.) biphenylether, isopropylidinediphenylphenoxy, biphenyl sulfone, biphenylsulfide, norbornyl and hexafluoromethylbiphenyl, etc. In one embodiment, R³⁴ and R³⁵ are benzene.

A is selected from a divalent C5-C20 aryl, or polycyclic aryl comprising two or more C5-C20 aryl groups. The polycyclic aryl groups can be a fused ring or an unfused system joined by a linker group. Examples of suitable aryl and/or polycyclic aryl groups for R¹ include, but are not limited to, benzene, naphthalene, benzophenone, biphenyl, a biphenyl alkane (e.g., a biphenyl group with an alkyl linker chosen from a C1-C20 alkyl such as, but not limited to, biphenyl methane, biphenyl ethane, biphenyl propane, biphenyl isopropane, biphenyl butane, biphenyl isobutene, biphenyl tertbutane, biphenyl hexane, biphenyl octane, etc.) biphenylether, isopropylidinediphenylphenoxy, biphenyl sulfone, biphenylsulfide, norbornyl and hexafluoromethylbiphenyl, etc. In one embodiment, R¹ is benzene.

R³⁶, R³⁷, R³⁸, R³⁹, R⁴⁰, and R⁴¹ are each independently selected from a C1-C10 alkyl and a C6-C20 aryl. In embodiments, R³⁶, R³⁷, R³⁸, R³⁹, R⁴⁰, and R⁴¹ are selected from a C1-C10 alkyl, a C2-C8 alkyl, or a C4-C6 alkyl. In one embodiment R³⁶, R³⁷, R³⁸, R³⁹, R⁴⁰, and R⁴¹ are each methyl.

In one embodiment, x is an integer of from 1 to about 200, from about 5 to about 175, from about 10 to about 150, from about 25 to about 135, from about 50 to about 110, or from about 75 to about 100.

In one embodiment, y is an integer of from about 1 to about 30, from about 2 to about 25, from about 5 to about 20, or from about 10 to about 15.

In one embodiment the siloxane-imide copolymer has the following structure:

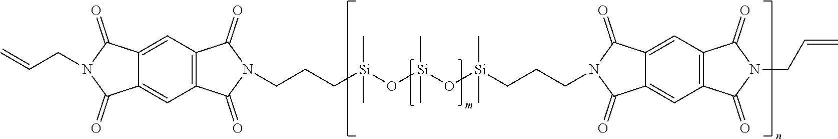

In one embodiment, the siloxane-imide copolymer is a polymer of the formulas:

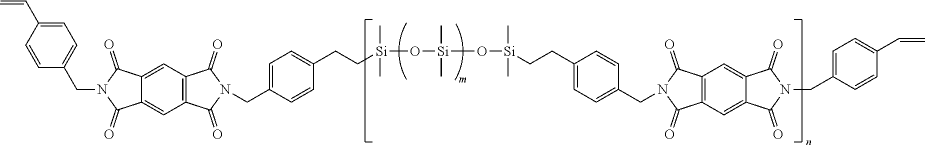

Without being bound to any particular theory, the imide-functional compounds may be employed to improve recession of the cured material. These materials are more difficult to erode and provide additional latent carbon content to the composition.

When a siloxane-imide copolymer is employed, the siloxane-imide polymer may be present in an amount of from about 15 wt. % to about 94 wt. %, from about 20 wt. % to about 90 wt. %, from about 25 wt. % to about 80 wt. %, from about 30 wt. % to about 75 wt. %, or from about 40 wt. % to about 60 wt. %. In one embodiment, the composition comprises the base silicone material, mullite, silicon carbide, boric anhydride, and an aryl substituted cyclosiloxane. In one embodiment, the composition comprises the base silicone material and:
from about 5 wt. % to about 50 wt. %, from about 10 wt. % to about 40 wt. %, from about 15 wt. % to about 35 wt. %, or from about 20 wt. % to about 30 wt. % of mullite powder based on the total weight of the composition;
about 1 wt. % to about 10 wt. %, from about 2 wt. % to about 8 wt. %, or from about 4 wt. % to about 6 wt. % of silicon carbide based on the total weight of the composition;
from about 0.5 wt. % to about 5 wt. %, from about 0.75 wt. % to about 4.5 wt. %, from about 1 wt. % to about 4 wt. %, from about 1.5 wt. % to about 3.5 wt. %, or from about 2 wt. % to about 3 wt. % of boric anhydride based on the total weight of the composition; and
from about 0.5 wt. % to about 10 wt. %, from about 1 wt. % to about 8 wt. %, from about 2 wt. % to about 6 wt. %, or from about 3 wt. % to about 5 wt. % of an aryl substituted cyclosiloxane based on the total weight of the composition.

In one embodiment, the composition comprises the base silicone material, mullite, silicon carbide, boric anhydride, an aryl substituted cyclosiloxane, and alumina. In one embodiment, the composition comprises the base silicone and
from about 5 wt. % to about 50 wt. %, from about 10 wt. % to about 40 wt. %, from about 15 wt. % to about 35 wt. %, or from about 20 wt. % to about 30 wt. % of mullite powder based on the total weight of the composition;
from about 1 wt. % to about 10 wt. %, from about 2 wt. % to about 8 wt. %, or from about 4 wt. % to about 6 wt. % of silicon carbide based on the total weight of the composition;
from about 0.5 wt. % to about 5 wt. %, from about 0.75 wt. % to about 4.5 wt. %, from about 1 wt. % to about 4 wt. %, from about 1.5 wt. % to about 3.5 wt. %, or from about 2 wt. % to about 3 wt. % of boric anhydride based on the total weight of the composition; and
from about 0.5 wt. % to about 10 wt. %, from about 1 wt. % to about 8 wt. %, from about 2 wt. % to about 6 wt. %, or from about 3 wt. % to about 5 wt. % of an aryl substituted cyclosiloxane based on the total weight of the composition.

In one embodiment the composition comprises the base silicone material, mullite, silicon carbide, boric anhydride, and carbon fiber. In one embodiment, the composition comprises the base silicone and:
from about 5 wt. % to about 50 wt. %, from about 10 wt. % to about 40 wt. %, from about 15 wt. % to about 35 wt. %, or from about 20 wt. % to about 30 wt. % of mullite powder based on the total weight of the composition;
from about 1 wt. % to about 10 wt. %, from about 2 wt. % to about 8 wt. %, or from about 4 wt. % to about 6 wt. % of silicon carbide based on the total weight of the composition;
from about 0.5 wt. % to about 5 wt. %, from about 0.75 wt. % to about 4.5 wt. %, from about 1 wt. % to about 4 wt. %, from about 1.5 wt. % to about 3.5 wt. %, or from about 2 wt. % to about 3 wt. % of boric anhydride based on the total weight of the composition; and
from about 1 wt. % to about 35 wt. %, from about 2 wt. % to about 30 wt. %, from about 5 wt. % to about 25 wt. %, from about 7 wt. % to about 20 wt. %, from about 10 wt. % to about 17 wt. %, or from about 12 wt. % to about 15 wt. % of carbon fiber based on the total weight of the composition.

The composition can be employed to form a cured material. The composition coated to the surface of the above-mentioned parts can adhere to a substrate and the cured product of the composition by allowing to stand at room temperature (for example, 23° C.) or heating to a higher temperature and curing. When heating to a higher temperature, curing can be carried out in a shorter time than at room temperature, thereby improvement in work efficiency can be achieved.

The heating conditions can be appropriately adjusted according to the heat resistant temperature of the member to which the composition is applied, and the curing time can be determined. For example, heat from exceeding room temperature (23° C.) to 200° C. or lower can be applied in the range for 1 minute to 2 weeks, or from 5 minutes to 72 hours. The heating temperature is preferably 40 to 180° C. from the viewpoint of ease of operation, and particularly preferably 50 to 150° C. The heating time is generally from 5 minutes to 72 hours from the viewpoint of simplicity of the curing processes, and even from 5 minutes to 24 hours. Also, when it is cured at room temperature, the curing time is about 1 week or shorter, about 72 hours or shorter, and even about 24 hours or shorter.

The composition can be applied to and form a cured material on a variety of substrates including, but not limited to, metallic substrates, polymeric substrates, and the like. Examples of suitable substrates include, but are not limited to, aluminum, copper, nickel, iron, brass, niobium, stainless steel, carbon steel, alloys of two or more such materials, etc.; refractory metals such as, but not limited to, tungsten, rhenium, molybdenum, etc.; titanium alloys; epoxy resin, polyester resin such as polyethylene terephthalate, polybutylene terephthalate (PBT) resin, etc., engineering plastics such as polycarbonate resin, acrylic resin, polyimide resin, phenol resin, polyamide resin, polyphenylene sulfide (PPS) resin, modified polyphenylene ether (PPE) resin, etc.; glass, etc. Some non-limiting examples of metal alloys include niobium alloys, nickel-based super alloys (e.g., those sold under the tradenames Inconel™, Hastelloy™, Rene, and the like), copper alloys (e.g., Narloy-Z, OFCH, and the like), etc.

The composition can be employed as a coating, a gap filler, a potting material, adhesive, and the like. In, the composition may be a primerless material and/or free of any adhesion promoters. In particular, the present compositions have been found to, upon curing, exhibit good adhesion in the absence of a primer and/or an adhesion promoter.

Upon exposure to relatively high temperatures, the material forms a ceramic char. The ceramic char may protect the underlying substrate from damage that could occur from exposure to extreme temperatures or heat flux. In embodiments, a substrate comprising a cured material formed from the present compositions may be suitably protected upon exposure to temperatures of from about 500° C. to about 2000° C., from about 700° C. to about 1800° C., from about 1000° C. to about 1500° C. A substrate comprising the cured material may have a heat flux (i.e., the rate of energy transfer through the cured material) of greater than about 20 W/cm², greater than about 30 W/cm², greater than about 50 W/cm², greater than about 75 W/cm², greater than about 100 W/cm², greater than about 125 W/cm², greater than about 150 W/cm², greater than about 175 W/cm², greater than about 200 W/cm², greater than about 225 W/cm², greater than about 250 W/cm², greater than about 275 W/cm², greater than about 300 W/cm², greater than about 350 W/cm², greater than about 400 W/cm², greater than about 450 W/cm², or even greater than about W/cm². In embodiments, a substrate comprising the cured material has a heat flux of from about about 20 W/cm² to about 1500 W/cm², from about 50 W/cm² to about 1400 W/cm², from about 100 W/cm² to about 1300 W/cm², from about 150 W/cm² to about 1200 W/cm², from about 200 W/cm² to about 1100 W/cm², from about 250 W/cm² to about 1000 W/cm², from about 300 W/cm² to about 900 W/cm², from about 350 W/cm² to about 850 W/cm², from about 400 W/cm² to about 800 W/cm², from about 450 W/cm² to about 750 W/cm², or from about 500 W/cm² to about 700 W/cm². In embodiments, a substrate comprising the cured material has a heat flux of from about 100 W/cm² to about 1500 W/cm², from about 200 W/cm² to about 1400 W/cm², from about 400 W/cm² to about 1200 W/cm², or from about 500 W/cm² to about 1000 W/cm². In still other embodiments, a substrate comprising the cured material may have a heat flux of from about 20 W/cm² to about 100 W/cm², from about 25 W/cm² to about 95 W/cm², from about 30 W/cm² to about 90 W/cm², from about 40 W/cm² to about 85 W/cm², from about 50 W/cm² to about 80 W/cm², or from about 60 W/cm² to about 70 W/cm².

Aspects and embodiments of the present technology may be further understood with respect to the following examples. The examples are not intended to be limiting of any particular aspect of the invention.

### EXAMPLES

An example of this invention was prepared according to the state of the art by mixing 40.9 parts of dimethylvinylsilyl-terminated polydimethyldiphenylsiloxane containing 0.001 parts of Pt (0) with 12.6 parts of MQ vinyl silicone resin (M^{vi}Q) to afford a fluid of 6,000 cP viscosity. To this resin fortified dimethylvinylsilyl-terminated polydimethyldiphenylsiloxane was added 12 parts of Hy-Tech ceramic beads, 28 parts of mullite powder and 4 parts of boric anhydride. The mixture was then mixed at 1600 rpm in a FlackTek DAC 1100.2 VAC speed mixer for 60 second followed by 60 seconds of hand mixing with thorough bottom scraping. The mixture was speed mixed two more times at 1600 rpm for 30 second during each mixing with a 60-second hand mixing between the speed mixes. A curing agent comprising 2.5 parts of Parts of M^{H}Q resin were added to the resulting mixture, followed by further mixing to give the final formulation. This formulation was then poured into a mold and allowed to cure at ambient temperatures for 10 hours, at 65° C. for 1 hour or 150° C. for 15 minutes.

Other versions of this formulation were made with other components and varied concentrations of various components. Parts and figures refer to weight or weight parts per hundred (pph).

The above curing conditions vary with depth and size of the mold.

| | Control | Example | Example | Example | Example | Example |
|---|---|---|---|---|---|---|
| Material | (S006) | 1 (S074) | 2 (S076) | 3 (S079) | 4 (S028) | 5 (S075) |
| M^{Vi}Q | | 10 | 17.9 | 17.3 | 12.6 | 10.7 |
| Vinyl polydiorgano-siloxane | 40.8 | 35 | 36.4 | | 40.9 | 37.3 |
| Pt Catalyst | 0.001 | 0.001 | 0.001 | 0.001 | 0.001 | 0.001 |
| Alkenyldiimidsiloxane | | | | 51.8 | | |
| TiB2 | | | | | 28 | |
| CaCO3 | | | | | | |
| Celite Superfloss | | | | | | |
| ZnO | | | | | | |
| Phenyl Tetramer | | 1.2 | | | | 1.3 |
| Alumina | 1 | 1 | | | | 1 |
| Carbon Black | | | | | | |
| Thixotropic agent | | | | | | |
| Red Iron Oxide | | | 29.2 | | | |
| Hy-Tech Ceramic Beads | | | | | 12 | |
| Aluminum Powder | 0.2 | 1.8 | | | | 1 |
| Carbon Fiber | 3.5 | 5 | 4.6 | 2.1 | | 2.7 |
| Mullite powder | | 28.6 | 8.0 | 20.9 | | 30.6 |
| Silica | 45 | 5.7 | | | | 3.5 |
| Silicon Carbide | 5 | 4.6 | | 4.5 | | 4.9 |
| Boric Anhydride | 0 | 3.1 | | 1.5 | 4 | 3.4 |
| MQ^{H} | 4.5 | 4 | 3.9 | 1.9 | 2.5 | 4.1 |
| Total | 100 | 100 | 100 | 100 | 100 | 100 |

The compositions prepared are shown in Table 1 and Table 2 Table 1

TABLE 2

| | Example 6 | Example 7 | Example 8 | Example 9 | Example 10 |
|---|---|---|---|---|---|
| Material | (S054) | (S078) | (S027) | (S077) | (S026) |
| M^{Vi}Q | 10.5 | 10.7 | 11.8 | 11.3 | 12.6 |
| Vinyl | 34.1 | | 38.3 | 39.3 | 40.0 |
| polydiorganosiloxane | | | | | |
| Pt Catalyst | 0.001 | 0.001 | 0.001 | 0.001 | 0.001 |
| Alkenyldiimidsiloxane | | 32.1 | | | |
| TiB2 | | | | | |
| CaCO3 | | | | | 22.4 |
| Celite Superfloss | | | 12.5 | 8.3 | |
| ZnO | | | | | 12 |
| Phenyl Tetramer | | | | | |
| Alumina | | | | | |
| Carbon Black | | | | | 2.6 |
| Thixin-R | | | 1.5 | | |
| Red Iron Oxide | | | 33.0 | 28.6 | |
| Hy-Tech Ceramic | | | | | |
| Beads | | | | | |
| Aluminum Powder | | | | | |
| Carbon Fiber | 5.2 | 33.3 | | 5 | |
| Mullite powder | 40 | 16.2 | | | |
| Silica | | | | | 8 |
| Silicon Carbide | 4.8 | 4.7 | | | |
| Boric Anhydride | 3.3 | 1.5 | | 3.2 | |
| MQ^{H} | 2.1 | 1.5 | 2.9 | 4.3 | 2.4 |
| Total | 100 | 100 | 100 | 100 | 100 |

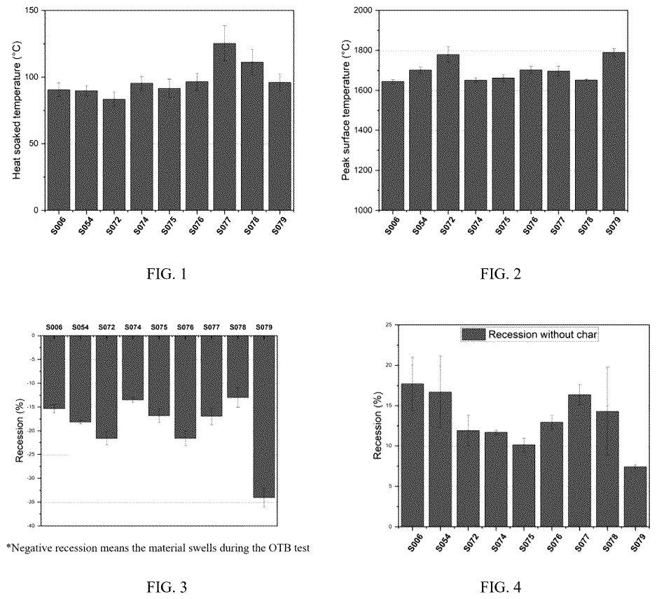

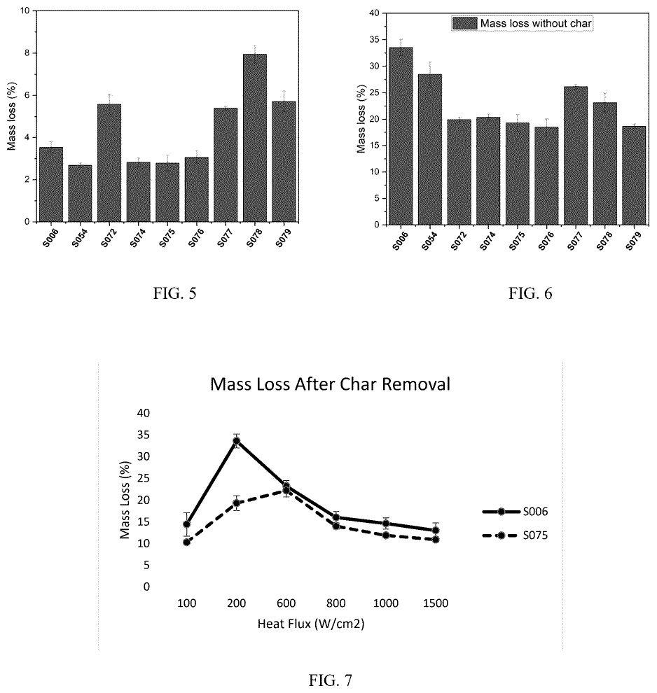

FIGS. 1-6 show different performance characteristics of selected compositions. In particular, the figures show heat soak temperature (FIG. 1), peak surface temperature (FIG. 2), recession (FIG. 3), recession without char (FIG. 4), mass loss (FIG. 5), and mass loss without char (FIG. 6). In the figures, the compositions are compared to a Comparative Example 1 (CE-1; S006), which is formed from DC93-104, an ablative material available from Dow Corning. Examples 4 and 8, which do not contain mullite and carbon fiber, are also comparative examples.

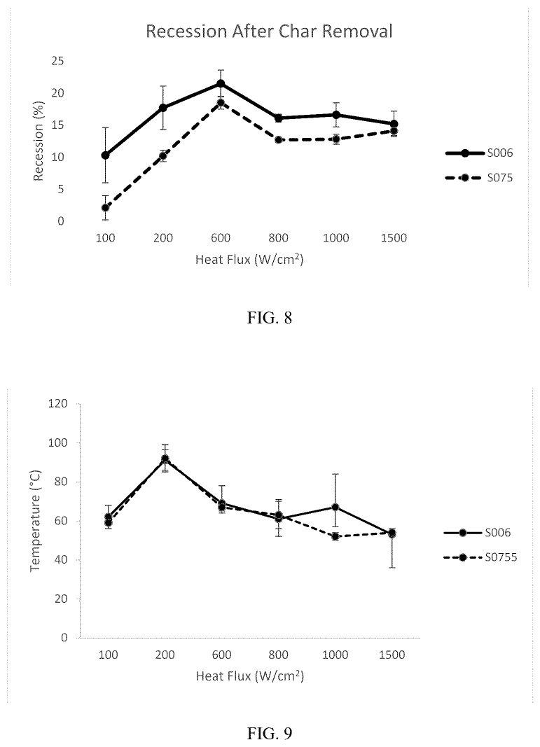

FIGS. 7-9 compare the mass loss after char (FIG. 7), recession after char (FIG. 8), and heat soak temperature (FIG. 9) of Example 5 with that of DC93-104.

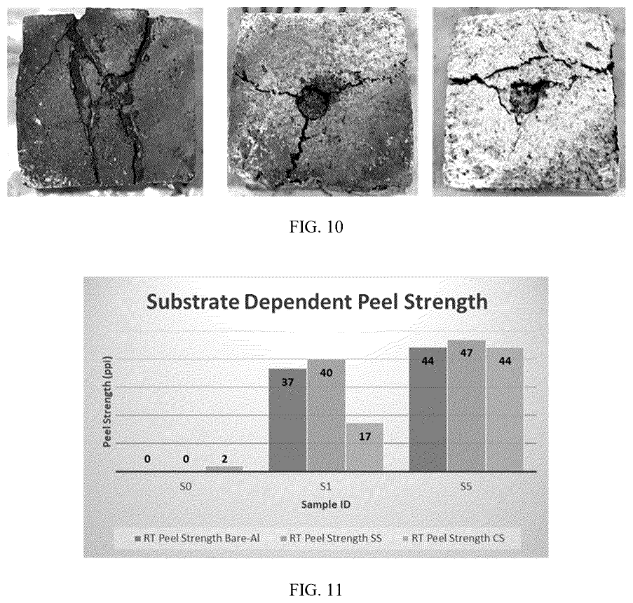

Char strength was evaluated for the comparative example CE-1, Example 5, and Example 6. Char strength is evaluated by Instron extensometer. As shown in Table 3, the compositions in accordance with the present technology show a significant increase in char strength. Further, as shown in FIG. 10, Example 5 (right photo) and Example 6 (center photo) experience significantly less cracking compared to the DC93-104 material (left photo).

TABLE 3

| Sample ID | Maximum Char Force |
|---|---|
| CE-1 | 137 ± 60.7 |
| Example 6 | 560 ± 51.2 |
| Example 5 | 500 ± 7.4 |

The adhesion of Examples 5 and 6 on various substrates was also examined. Adhesion was evaluated on bare aluminum, stainless steel, and carbon substrates. Peel adhesion was measured for a 6-inch (152.4 mm) ablative coating of about 3/16-inch thickness, and which was divided into three 25 mm (1 inch) sections by 450 cuts. Peeling was then done at an angle of 180° and at a rate of 50.8 mm (2 inch)/minute from aluminum, stainless steel, or carbon substrates using an Instron adhesion tester. The median pull value for the three sections is reported as the peel adhesion of the material and average % cohesive failure over the entire substrate area tested to the nearest 10% is also reported. Adhesion was also evaluated for DC93-104. As shown in FIG. 11, Examples 5 and 6 in accordance with the present technology exhibited excellent adhesion on each of the substrates, while the DC93-104 showed only minimal adhesion on the carbon substrate.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a char forming curable silicone composition. Modifications may occur to those skilled in the art and to those who may make and use the invention. The disclosed embodiments are merely for illustrative purposes and not intended to limit the scope of the invention or the subject matter set forth in the claims.

What is claimed is:

1. A composition comprising:
a base silicone material;
from about 5 wt. % to about 50 wt. % of mullite powder based on the total weight of the composition; and
from about 1 wt. % to about 35 wt. % of a carbon fiber filler based on the total weight of the composition.

2. The composition of claim 1 comprising from about 8 wt. % to about 40 wt. % of mullite powder based on the total weight of the composition.

3. The composition of claim 1 comprising from about 2 wt. % to about 10 wt. % of the carbon fiber filler based on the total weight of the composition.

4. The composition of claim 1 comprising silicon carbide.

5. The composition of claim 4, wherein the silicon carbide is present in an amount of from about 1 wt. % to about 10 wt. % based on the total weight of the composition.

6. The composition of claim 1 comprising boric anhydride.

7. The composition of claim 6, wherein the boric anhydride is present in an amount of from about 0.5 wt. % to about 5 wt. % based on the total weight of the composition.

8. The composition of claim 1 comprising aluminum powder.

9. The composition of claim 8, wherein the alumina powder is present in an amount of from about 0 wt. % to about 6 wt. % based on the total weight of the composition.

10. The composition of claim 1 comprising an oxide filler selected from alumina, silica, or iron oxide.

11. The composition of claim 1 comprising an aryl substituted cyclosiloxane.

12. The composition of claim 11, wherein the aryl substituted cyclosiloxane is selected from hexaphenyl cyclotrisiloxane, octaphenyl cyclotetrasiloxane, or a combination thereof.

13. The composition of claim 11, wherein the aryl substituted cyclosiloxane is present in an amount of from about 0.5 wt. % to about 3 wt. % based on the total weight of the composition.

14. The composition of claim 1, wherein the base silicone material is an addition curable resin comprising an alkenyl-functional polydiorganosiloxane and a hydride-functional polydiorganosiloxane.

15. The composition of claim 14, wherein the alkenyl-functional polydiorganosiloxane is selected from a MQ alkenyl-functional resin, and the hydride-functional polydiorganosiloxane is selected from a MQ hydride-functional resin.

16. The composition of claim 1 comprising an alkenyl-functional organopolysiloxane.

17. The composition of claim 16, wherein the alkenyl-functional organopolysiloxane is selected from an alkenyl-terminated polydimethyldiphenylsiloxane.

18. The composition of claim 16, wherein the alkenyl-functional organopolysiloxane is selected from an alkenyl-functional siloxane-imide polymer.

19. The composition of claim 18, wherein the alkenyl-functional siloxane-imide polymer is of the formula (i) or (ii): 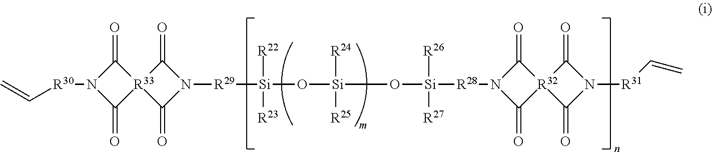
R²², R²³, R²⁴, R²⁵, R²⁶, and R²⁷ are each independently selected from a C1-C10 alkyl and a C6-C20 aryl;
R²⁸ and R²⁹ are independently selected from a divalent C2-C10 alkyl and a divalent C6-C20 aryl-containing groups.
R³⁰ and R³¹ are independently selected from a bond a C1-C20 divalent hydrocarbon, a C4-C20 branched divalent hydrocarbon, or a C4-C30 cyclic containing hydrocarbon group;
R³² and R³³ are independently chosen from a C5-C20 aryl, a polycyclic aryl group comprising two or more C5-C20 aryl groups, where R³² and R³³ can be unsubstituted or substituted with a C1-C6 alkyl, a halogen, a haloalkyl, a hydroxy, and/or a C1-C5 alkoxy groups;
m is an integer from 1 to about 200; and
n is an integer from 1 to about 30; 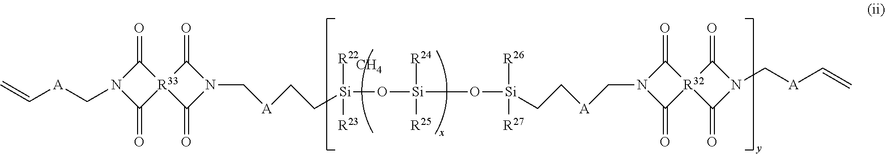
where
R³⁴ and R³⁵ are independently chosen from a C5-C20 aryl, a polycyclic aryl group comprising two or more C5-C20 aryl groups, where R³⁴ and R³⁵ can be unsubstituted or substituted with a C1-C6 alkyl, a halogen, a haloalkyl, a hydroxy, and/or a C1-C5 alkoxy groups;
A may be chosen from C5-C20 aryl;
R³⁶, R³⁷, R³⁸, R³⁹, R⁴⁰, and R⁴¹ may be same or different and can be chosen from C1-C10 alkyl and C6-C20 aryl;
x is an integer from 1 to about 200; and
y is an integer from 1 to about 30.

20. The composition of claim 1 comprising mullite, silicon carbide, boric anhydride, and an aryl substituted cyclosiloxane.

21. The composition of claim 20 comprising: from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; and from about 0.5 wt. % to about 10 wt. % of an aryl substituted cyclosiloxane based on the total weight of the composition.

22. The composition of claim 1 comprising mullite, silicon carbide, boric anhydride, an aryl substituted cyclosiloxane, and alumina.

23. The composition of claim 22 comprising: from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; from about 0.5 wt. % to about 10 wt. % of an aryl substituted cyclosiloxane based on the total weight of the composition, and from about 0.1 wt. % to about 5 wt. % of alumina based on the total weight of the composition.

24. The composition of claim 1 comprising mullite, silicon carbide, boric anhydride, and carbon fiber.

25. The composition of claim 24 comprising: from about 5 wt. % to about 50 wt. % of mullite powder based on the total weight of the composition; from about 1 wt. % to about 10 wt. % of silicon carbide based on the total weight of the composition; from about 0.5 wt. % to about 5 wt. % of boric anhydride based on the total weight of the composition; and from about 1 wt. % to about 35 wt. % of carbon fiber based on the total weight of the composition.

26. The composition of claim 1, wherein the composition is free of an adhesion promoter.

27. A cured material formed from the composition of claim 1.

28. An article comprising a substrate and the cured material of claim 27 disposed on a surface of the substrate.

29. The article of claim 28, wherein the cured material adheres to the surface of the substrate in the absence of a primer between the surface and the coating.

30. The article of claim 28, wherein the substrate is selected from a polymeric substrate, a metallic substrate, a fiber substrate, or a combination of two or more thereof.

31. The article of claim 28, wherein the substrate is selected from, aluminum, copper, nickel, iron, brass, niobium, stainless steel, carbon steel, tungsten, rhenium, molybdenum, titanium containing alloy, a niobium containing alloy, a nickel containing alloy, a copper containing alloy, a titanium containing alloy, an epoxy resin, a polyester resin, a polycarbonate resin, an acrylic resin, a polyimide resin, a phenolic resin, a polyamide resin, a polyphenylene sulfide resin, modified polyphenylene ether (PPE) resin, glass, a woven fiber material, a felt material, a carbon metal alloy, or a combination of two or more thereof.

32. The article of claim 28, wherein the cured material is free of a primer and/or an adhesion promoter.

33. The cured material of claim 27, wherein the cured material forms a ceramic char at a heat flux of about 20 W/cm² or greater.

34. The cured material of claim 27, wherein the cured material forms a ceramic char at a heat flux of about 100 W/cm² or greater.

35. The cured material of claim 27, wherein the cured material forms a ceramic char at a heat flux of about 200 W/cm².

36. The cured material of claim 27, wherein the cured material forms a ceramic char at a heat flux of from about 20 W/cm² to about 1500 W/cm².

37. The cured material of claim 27, wherein the cured material forms a ceramic char at a heat flux of from about 20 W/cm² to about 100 W/cm².
